(19) United States
(12) Patent Application Publication
(10) Pub. No.: US 2026/0203638 A1
(43) Pub. Date: Jul. 16, 2026

(54) Hybrid Quantum Autoencoder for Decoder in the Physical Layer

(71) Applicant: Telefonaktiebolaget LM Ericsson (publ), Stockholm (SE)

(72) Inventors: Bence Bakó, Budapest (HU); Zsolt Tabi, Budapest (HU); Péter Hága, Budapest (HU); Dániel Nagy, Budapest (HU); Peter Vaderna, Budapest (HU); Zsôfia Kallus, Budapest (HU); Zoltán Zimborás, Budapest (HU)

(21) Appl. No.: 19/136,718

(22) PCT Filed: Dec. 8, 2022
(86) PCT No.: PCT/SE2022/051161

§ 371 Date: Jun. 6, 2025

(51) Int. Cl. G06N 10/70; G06N 3/04; G06N 10/20; G06N 10/40

(52) U.S. Cl. CPC G06N 10/70; G06N 3/04; G06N 10/20; G06N 10/40

(57) ABSTRACT

A decoder apparatus for use in a radio communications system comprises a quantum circuit (540) configured to receive an output from a communications channel that comprises a radio channel, and to decode the output into output information symbols. The quantum circuit comprises a quantum neural network, QNN, (542) with a plurality of trainable QNN weights, where the QNN comprises at least a first embedding layer, configured to receive the output from the communications channel and to encode the output into first qubits, and a first transforming layer, configured to transform the qubits using a plurality of quantum gates, the first embedding layer implementing weighted rotation angle embedding of the output from the communications channel using at least a first trainable weight.

### TECHNICAL FIELD

The present disclosure is generally related to wireless communications and is more particularly related to the use of quantum neural networks in a decoder of a radio receiver.

### BACKGROUND

Machine-learning (ML) methods and deep-learning (DL) solutions mark a new era in information processing and analytics. An autoencoder (AE) is a well-established type of ML/DL method for denoising and data compression which can be trained in a self-supervised way. More particularly, an autoencoder is a type of artificial neural network (ANN) used to learn how to efficiently represent unlabeled data.

In an autoencoder, the initial input dimension is reduced by an encoding block into a lower-dimensional representation space, called the latent space. In a decoding block, these compressed vectors are transformed back into the original higher dimensional representation. The reconstructed vectors may then be used for self-supervised feedback on the compression quality, by minimizing the distance between the reconstructed vectors and the corresponding input vectors, during training of an AE application.

Deep learning methods as adapted for and implemented in the physical layer of a radio channel have been discussed, e.g., in O'shea, T., & Hoydis, J. (2017), “An introduction to deep learning for the physical layer,” IEEE Transactions on Cognitive Communications and Networking, 3(4), 563-575.

This disclosure focuses on physical layer AE (PAE) methods. In this model, the input to the noisy channel is a one-hot vector form of messages that have been transformed by an encoder, and the output of the system is a probability distribution over all possible messages, to select the most likely as output.

Joint optimization of transmitter and receiver ML components to learn channel models was introduced, in the O'Shea reference cited above, as an alternative to rule-based communications system design. By representing the transmitter, channel, and receiver as a single autoencoder, the system can be trained to learn the best constellation for the chosen modulation scheme, in a given environment.

FIG. 1 illustrates a simplified schematic of an autoencoder structure as applied to the physical layer. The system shown in FIG. 1 includes a transmitter 110 and a receiver 130, with a channel 120, e.g., a radio channel, between them. Note that radio circuitry that forms part of the communication link, such as amplifiers, frequency converters, antennas, filters, may be modeled as part of the channel, so the term channel as used herein may refer to the physical medium through which a communications signal passes, e.g., the radio channel, or to a composite channel comprising the physical medium and at least some of surrounding circuitry that processes the communications signal for transmission and/or reception, i.e., after encoding of the signal in the transmitter and before decoding in the receiver.

As seen in FIG. 1, transmission of an original message s through the channel adds noise to and/or distorts the message. In the figure, both of these effects may be modeled as part of the channel 120. The illustrated autoencoder structure includes deep neural networks in both the transmitter and receiver to implement the end-to-end autoencoder—hence, there are multiple dense layers and a normalization layer in the transmitter 110, as well as multiple dense layers and an activation function in the receiver 130, with the output being probabilities associated with each of the possible values of the original message s. The highest probability value is selected as an estimate s of the original message s.

Existing solutions leveraging classical ML for encoding/decoding problems in the physical layer (i.e., the classical autoencoder) are motivated by the desire for improved solutions to the non-linear problems presented by complex channel models. However, ML techniques can reach a limitation in terms of resolving complex problems and nonlinearity in a compact solution, i.e., with respect to efficiently handling exploding problem spaces. These limitations will increase in importance in next-generation telco systems, e.g., in more challenging environments, dense communication networks, etc.

### SUMMARY

Example embodiments of the techniques, apparatuses and systems disclosed herein include a decoder apparatus that comprises a quantum circuit configured to receive an output from a communications channel that comprises a radio channel and to decode the output into output information symbols. The quantum circuit comprises a quantum neural network (QNN) with a plurality of trainable QNN weights. The QNN comprises at least a first embedding layer, configured to receive the output from the communications channel and to encode the output into first qubits, and a first transforming layer, configured to transform the qubits using a plurality of quantum gates.

This example decoder apparatus may form part of a communication system that comprises the decoder apparatus as well as an encoder module configured to transform input information symbols into a two-dimensional signal space for transmission through the communications channel, using a plurality of trainable encoder weights. In some embodiments, the encoder module implements an artificial neural network, and the plurality of trainable encoder weights comprise trainable ANN weights.

In addition to the decoder apparatus and the encoder module, a communication system according to several embodiments described herein may further comprise an optimization module configured to receive a plurality of the input information signals and corresponding ones of the output information symbols and to adapt the trainable encoder weights and trainable QNN weights for input to the encoder circuit and QNN, respectively, based on the plurality of the input information signals and the corresponding ones of the output information symbols. The optimization module may be configured to jointly optimize the encoder weights and the QNN weights using a categorical cross-entropy loss function.

Other embodiments include corresponding methods for quantum decoding. An example method comprises receiving an output from a communications channel that comprises a radio channel, and decoding the output into output information symbols, in a quantum circuit comprising a ONN with a plurality of trainable QNN weights. The QNN again comprises at least a first embedding layer, configured to receive the output from the communications channel and to encode the output into first qubits, and a first transforming layer, configured to transform the qubits using a plurality of quantum gates, where the first embedding layer implements weighted rotation angle embedding of the output from the communications channel using at least a first trainable weight.

In some embodiments or instances, this example method further comprises, in an encoder separated from the decoder apparatus by the communications channel, transforming input information symbols into a two-dimensional signal space for transmission through the communications channel, using a plurality of trainable encoder weights. The method may still further comprise, in an optimization module, receiving a plurality of the input information signals and corresponding ones of the output information symbols and adapting the trainable encoder weights and trainable QNN weights for input to the encoder circuit and QNN, respectively, based on the plurality of the input information signals and the corresponding ones of the output information symbols.

Variations of these and other apparatuses, systems, and methods are described in further detail below.

### BRIEF DESCRIPTION OF THE FIGURES

FIG. 1 is a block diagram of an autoencoder.

FIG. 2 shows a quantum neural network (QNN) having multiple trainable layers.

FIG. 3 illustrates examples of encoding parts of a trainable QNN layer.

FIG. 4 is an example Ansatz for a transforming/decoding part of a trainable QNN layer.

FIG. 5 illustrates an end-to-end hybrid quantum-classical autoencoder, according to some of the presently disclosed embodiments.

FIG. 6 shows the architecture of a proof-of-concept autoencoder.

FIG. 7 is a process flow diagram illustrating an example method, according to some of the presently disclosed embodiments.

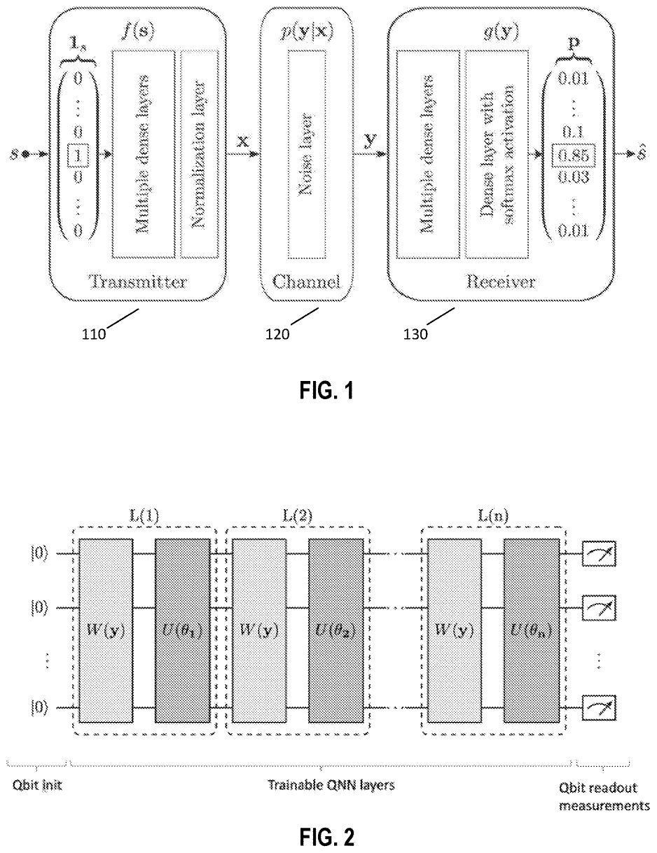

### DETAILED DESCRIPTION

Quantum-based machine learning presents a potential for leveraging a quantum processing unit (QPU) to process either quantum or classical information with quantum gate operations, e.g., in a quantum neural network (QNN) structure. These operations are parameterized and can be trained for optimal results in a hybrid training loop using classical optimizers.

Once trained, a QNN can be used for inference. For classical input data, the first step is to encode input features into the qubits, and a post processing of the resulting probability distribution follows the final qubit measurements to output the inferred result for each given application.

One general QNN Ansatz is shown in FIG. 2, where the recently introduced data re-uploading method is included as an optional component of the neural network structure. See, e.g., Schuld, M., Sweke, R., & Meyer, J. J. (2021), “Effect of data encoding on the expressive power of variational quantum-machine-learning models,” Physical Review A, 103(3), 032430. This structure includes an initialization with zero-state qubits, followed by a series of trainable QNN layers, where each layer is composed of parametrized data encoding W(y) and transforming U(θ) gates. A qubit readout is performed to create the classical output.

Quantum autoencoders have been defined for quantum state encoding. An example is Bravo-Prieto, Carlos, “Quantum autoencoders with enhanced data encoding,” Machine Learning: Science and Technology 2.3 (2021): 035028.

As noted above, machine-learning using conventional computing may be used to implement an autoencoder applied to the physical layer of a communications system, but the complexity of the channels in various environments may tax these systems beyond their limits. Given current research, however, quantum algorithms are expected to outperform classical machine learning. Disclosed herein are techniques and systems whereby an end-to-end communication system leverages quantum computing resources in the receiver end of the communication link. This structure, in which the receiver part is implemented as a decoder in the form of a quantum circuit, complements a traditional transmitter with an encoding part.

Described in detail below are a qubit encoding scheme for received classical information, as well as the structure of a quantum machine learning model. Also described is a training method that uses the entire end-to-end system to create the final hybrid quantum-classical autoencoder solution.

The model learns a constellation that is optimal against the channel degradation and distortion effects of the radio equipment. The model can be pre-trained by simulated or recorded channel models, in which case only the learned constellation is required for the local inference.

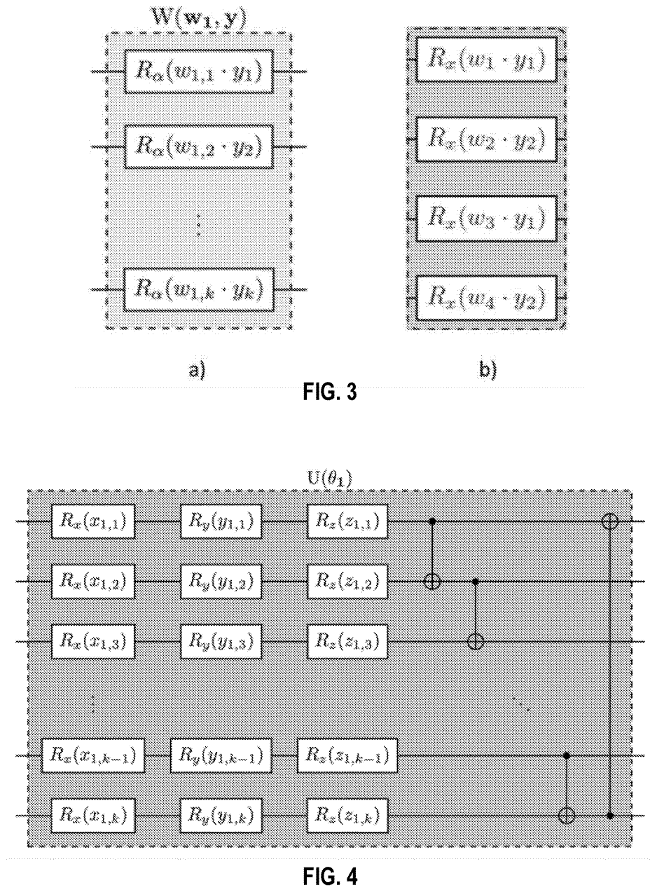

FIG. 3 illustrates two possible embedding methods for encoding classical input data of noisy symbols into the qubit circuit. Details of the two illustrated approaches are described in Schuld, M., Sweke, R., & Meyer, J. J. (2021), “Effect of data encoding on the expressive power of variational quantum-machine-learning models,” Physical Review A, 103(3), 032430. In the present context, for example, either of these encoding methods may be used for initially encoding the noisy symbols output from a communications channel comprising a radio channel, as well as for subsequently re-encoding the qubits after each transformation layer.

FIG. 3(a) illustrates weighted rotation angle embedding. This quantum circuit diagram shows the embedding of classical information into qubits, where W refers to the encoding sublayer in each trainable QNN layer in the system of FIG. 2. This can be the encoding part of each layer in cases when data re-uploading is used. (Data re-uploading in a quantum classifier is described in Pérez-Salinas et al., “Data re-uploading for a universal quantum classifier,” Quantum vol. 4, p. 226(2020 ).)

FIG. 3(b) illustrates weighted parallel (or double) re-uploading of noisy symbol input data. This quantum circuit diagram illustrates parallel encoding, for cases in which the channel output dimension is smaller than the number of qubits. The example shown in FIG. 3(b) is applicable for 16-QAM (k=4) and x-angle qubit encoding (a=x). In general, this double data re-uploading increases the efficiency of the circuit, so that a smaller number of layers can reach a desired QNN performance. This is part of a general trade-off between the available number of qubits and goodness of qubits allowing for higher number of layers.

So, either of the structures shown in FIG. 3 may be used as the encoding part W(y) in each trainable QNN layer in a decoder having a structure like that shown in FIG. 2. The transforming part U(θ) of each trainable layer may take the form of any of a variety of Ansatzes—one example Ansatz is shown in FIG. 4, which shows a unitary transformation that may form part of the first trainable QNN layer in the structure of FIG. 2, for example.

Note that in both FIGS. 3 and 4, Rᵣ represents a rotation gate on r-axis, while x_{i,j}, y_{i,j}, z_{i,j} are the rotation parameters in the i-th layer for the j-th qubit, where any or all of these rotation parameters can be trainable. In FIG. 4, entangling CNOT gates are represented by the vertical connections.

It will be appreciated that the layer structure shown in FIG. 4 generalizes well. The number of qubits scales logarithmically with the modulation order (e.g., the QAM order), while the depth of the circuit is linear with respect to the number of possible symbols.

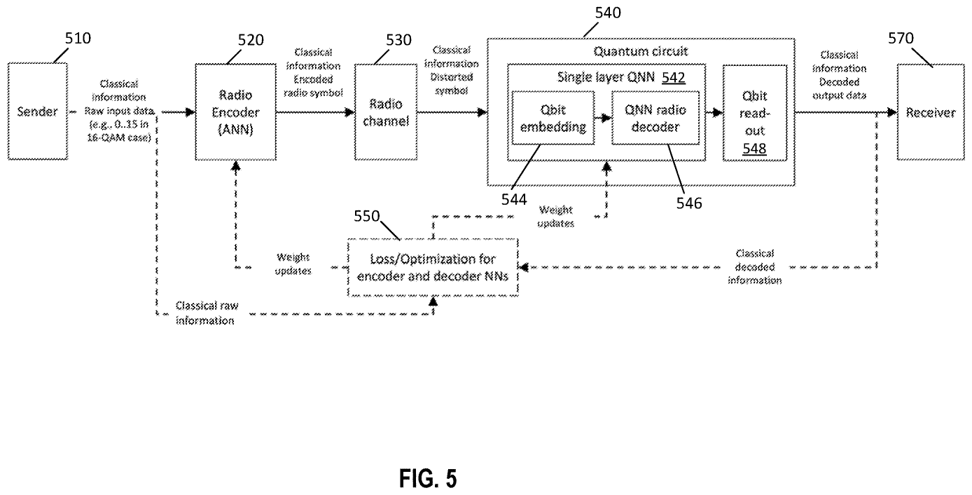

FIG. 5 illustrates a complete, end-to-end solution for the hybrid quantum-classical autoencoder. Note that dash elements and lines mark components and connections that are used only during the training phase. The remaining components and connections, marked with solid lines, are part of both the inference and training phases.

At the left-hand side of the figure is the Sender 510, which may be any data source. Sender 510 inputs classical information into the communication system in the form of raw data (which may be encrypted, error-encrypted, etc.), which in this example is encoded for 16-QAM, i.e., taking values of 0 to 15. This raw input data is provided to the radio encoder 520, which is configured to transform the raw input data into a reduced-dimension space. In this case, the radio encoder 520, which may implement an artificial neural network (ANN), may be configured to transform raw input symbols of a 16-QAM alphabet into a two-dimensional symbol space, for transmission through the communications channel. This may be done using a plurality of trainable encoder weights in the ANN.

The inputs to the radio encoder 520 may thus be represented as 16-QAM symbols s, each of which may be represented as an integer in the space [0 . . . 15]. The transformation provided by radio encoder 520 is a dimension reduction using classical methods. For example, linear embedding may be used to transform into two dimensions from the 16-dimensional space of the symbol input. The output from radio encoder 520 is a two-dimensional representation of the input symbol, which may be represented as a complex value x, which is normalized to fit radio channel constraints, e.g., using well-known energy or average power constraint methods.

The output x is supplied to the radio channel 530. As is well known, the radio channel 530 adds noise and distortion to the transmitted symbols as they traverse the channel. Note that for the purposes of modeling the system, the radio channel 530 may be considered to include not only the physical medium through which the radio signals propagate, i.e., the “air,” but may also be considered to include the radio components that transmit, receive, and condition the radio signals on either end of the link, e.g., the antennas, amplifiers, filters, etc.

The input to the radio channel 530 is the transformed, reduced-dimension representation x, while the output is a noisy, distorted version of that signal, y. This is a classical information, distorted signal. Note that during the inference phase, i.e., when data is actually being transmitted from one end to the other, the radio channel 530 is, generally, a live channel, which may vary over time. During the training phase, a live channel may be used, or a model of the channel may be used, or some combination of both may be used, to produce values for the training weights in the radio encoder 520 and the quantum circuit 540, which is described next.

The noisy, distorted signal y is fed to quantum circuit 540, which comprises, in this illustrated example, a single-layer quantum neural network (QNN) 542, which in turn comprises a QNN qubit-embedding layer 544 and a QNN decoder/transformation layer 546. Layers 544 and 546 correspond to a single instance each of the encoding W(y) sub-layers and transforming U(θ) sub-layers shown in FIG. 2. It will be appreciated that the single-layer network shown in FIG. 5 may be extended to include multiple layers. The output, whether from one or multiple of these layers is fed to a qubit-readout layer 548, which converts the qubits into probability values, which in turn can be converted to output data. When operating in the training phase, the probability values themselves are used as the input to an optimizer, while in the inference phase, the highest probability symbol at each time instance is the output-in the inference phase, the highest probability symbol at each time instance is selected and fed to receiver 570, which is the consumer of the received data.

So, the distorted symbol y is the input to quantum circuit 540, which represents the decoder in the receiver part of the communication system. In its simplest form, quantum circuit 540 only contains a single layer of the QNN shown in FIG. 2, where the embedding layer 544 and the decoder layer 546 of the QNN 542 correspond to the W and U components exemplified in FIGS. 3 and 4.

In the embedding layer 544, a set of quantum gates are used to encode the classical information signal y into the qubits. In the case of QAM, the W encoding may be chosen to be Rx rotation encoding, meaning: yᵢ→exp(−iwᵢyᵢσₓ/2) where i∈[1,2] and wᵢ are the trainable weight parameters and σₓ is the first Pauli matrix. For 4-QAM, the embedding layer keeps two dimensions, for 16-QAM, the input data yᵢ may be embedded in parallel as depicted in FIG. 3(b). More generally, see Schuld, M., Sweke, R., & Meyer, J. J., “Effect of data encoding on the expressive power of variational quantum-machine-learning models,” Physical Review A, 103(3), 032430 (2021).

In the transforming/decoding layer 546, the quantum neural network transformation U is chosen to be a fixed structure with trainable parameters at every rotation gate and a strongly entangling structure of CNOT gates, e.g., as shown in FIG. 4. The final measurement layer, qubit-readout layer 548, may be a computation basis projective measurement on each qubit. The resulting string of 0, 1 values specifies a symbol value according to the QAM alphabet, in binary representation.

The output of the quantum circuit 540 is used for training, in the training phase, and is the output of the communication system in the inference phase. By running the circuit many times, we can create a probability distribution over the basis states, i.e., the distribution is defined over the possible symbol values, i.e., over dimension M of the used QAM. The number of run times is called the number of shots—a hyper parameter of the training process. For further details on circuits, see Schuld, Maria, et al., “Circuit-centric quantum classifiers,” Physical Review A 101.3 (2020): 032308.

The trainable, parametrized QNN 542 and the radio encoder 520 get weight updates, during a training phase, from the classical loss/optimization module 550, which jointly optimizes these weights by, for example, minimizing a loss function, e.g., a categorical cross-entropy loss function. Using separate process for the ANN and QNN, weight updates are served during training phase, with both using the same common target variable of raw input form of the message to be reconstructed. Hence, this architecture presents an end-to-end training method.

The operation of the optimization module 550 is similar to well-known machine-learning training methods, but the optimization module 550 performs simultaneous training of a classical (i.e., non-quantum) encoder 520 and a quantum neural network 542 in the quantum decoder circuit 540. These are trained until optimal weight parameters are set in their fixed, respective structures.

In more detail, the machine-learning training may use a well-known categorical cross-entropy measure as a loss value, calculated between two input distributions. The optimizer will use the gradients of the trainable parameters within the encoder and decoder modules for their weight updates. Some well-known optimizer methods include SGD, Adam, Adadelta, and Adamax. The learning/training may thus comprise the calculation of a gradient for a given choice of weight parameters, followed by the proposal of a new set of weights, in each step of an iterative process, to test the weights against the encoding and decoding over the noisy channel to achieve a better loss value (the value of the loss function). The gradients for the encoder ANN can be calculated by software in a central computing module, for example, while the gradients for the QNN parameters can be calculated via the parameter-shift rule when a real quantum-processing unit is used. (See Schuld, Maria, et al., “Evaluating analytic gradients on quantum hardware,” Physical Review A 99.3 (2019): 032331.) For simulated QPU training, the gradients can be calculated by software only.

The inputs to the optimization module 550 are thus samples of the classical, one-hot encoded, raw information for input to the encoder and that are to be reconstructed by the end-to-end autoencoder. A well-trained encoder/decoder pair will perfectly reconstruct this original distribution. Also input to the optimization module 550 is the output distribution from the quantum circuit 540, which correspond to specific weight parameters. The gradients of the trainable parameters in the encoder 520 and the QNN 542 may be inputs to the optimization module 550, or calculated within the optimization module 550, in various embodiments. The output from optimization module 550 are weight parameter updates for radio encoder 520 and for QNN 542, as jointly optimized against the training data.

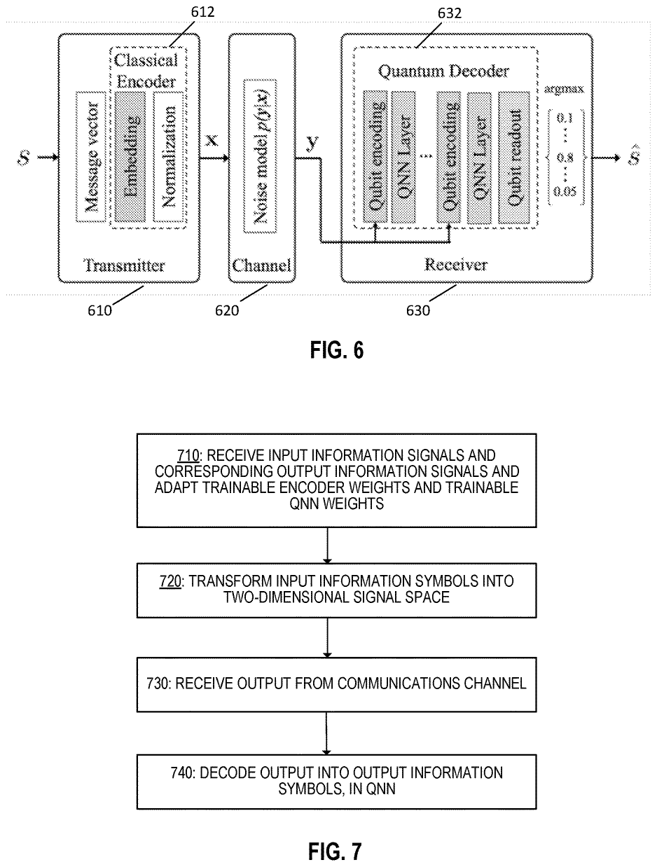

FIG. 6 illustrates the high-level architecture of a proof-of-concept hybrid quantum-classical encoder, employing the techniques described above and including a transmitter 610, channel 620, and receiver 630. This proof-of-concept implemented a 16-QAM, using a classical linear embedding in the encoder 612 and a 4-qubit quantum circuit 632 as the decoder. With repeated measurements of qubit states at the readout step, for each re-running of the circuit, the output of the decoder circuit becomes a probability distribution over the 16 basis states giving the probabilities of the 16 decoded symbols.

For the Ansatz of QNN, W (see FIGS. 2 and 3) was chosen to be a weighted double data re-uploading method. U (see FIGS. 2 and 4) was chosen to be a strongly entangling structure with general rotation gates separated into x, y, z gates on each qubit before a ring CNOT structure.

For the proof of concept, the W encoding form shown in FIG. 3(b) was used, but the form shown in FIG. 3(a) may be used to result in efficient decoding by a quantum processing unit. The proof of concept tested a strongly entangled structure of U in the QNN, but in general, using even a minimum number of one CNOT gates can already introduce quantum effect. When parallel encoding is used for higher-level QAM cases, each of the qubit pairs should have a CNOT between them. In addition, when multiple channel use is implemented in the classical communication on the sender side (e.g., with repeated sending of each symbol), CNOT gate(s) should be implemented between the parallel encoding qubit pairs.

The proof-of-concept test measured the accuracy of the model by evaluating Symbol Error Rate (SER). The training method updated the network weights by use of the sparse categorical cross-entropy calculated between the generated distribution and the ground truth symbols. This loss function was used to calculate gradients in a mini-batch gradient descent, with a batch size of 64 and using the Adam optimizer. The number of shots for readout measurements was set to 1000, and a learning rate of 0.1 was used.

The proof-of-concept testing simulated for 16-QAM encoding with an AWGN channel simulator showed good performance of the proposed solution, for a reasonable number of layers (between 8 and 24), as compared to a classical machine-learning approach.

The 4-QAM and 16-QAM schemes discussed above can be scaled, in the encoding and quantum circuit Ansatz, to adapt to higher order QAM cases. The number of symbols, M (QAM order) is, by definition, a power of two. To represent a probability distribution over all the symbols, log(M) qubits are needed. The proposed encoding methods and core layers are generic for any qubit number, and the whole circuit depth scales linearly with M.

Parallel encoding can be used to increase the expressivity of the QNN without increasing the number of layers. This is implemented when a higher number of qubits is available for lower-dimensional channel output cases.

Each layer is defined by W encoding and U unitary transformation defined by an Ansatz structure. For the examples in FIG. 3 and FIG. 4, this means k=log(M), and the connectivity can remain the chosen strongly entangling structure.

The encoding layers U can also be generalized, by moving from the general rotations x, y, z on each qubit followed by the strongly entangling ring CNOT structure to arbitrary rotation blocks that can be different for each qubit, with an arbitrary CNOT structure not having any particular predefined connectivity pattern.

In view of the detailed techniques, systems, and circuits described above, it will be appreciated that embodiments of the presently disclosed invention include a decoder apparatus that comprises a quantum circuit configured to receive an output from a communications channel that comprises a radio channel, and to decode the output into output information symbols, the quantum circuit comprising a quantum neural network (QNN) with a plurality of trainable QNN weights. Example structures and components of this QNN were shown in FIGS. 2-6. The QNN comprises at least a first embedding layer, configured to receive the output from the communications channel and to encode the output into first qubits, and a first transforming layer, configured to transform the qubits using a plurality of quantum gates. The first embedding layer implements weighted rotation angle embedding of the output from the communications channel using at least a first trainable weight. More generally, of course, the embedding layer may comprise multiple trainable weights. Likewise, the quantum gates of the first transforming layer may incorporate at least a second trainable weight. In some embodiments, the plurality of quantum gates of the first transforming layer includes one or more rotation gates for each of a plurality of qubits, each of one or more of the rotation gates having trainable rotation parameters. and further includes one or more CNOT gates arranged to entangle the qubits.

The decoder apparatus just described may form part of a communication system that comprises the decoder apparatus as well as an encoder module configured to transform input information symbols into a two-dimensional signal space for transmission through the communications channel, using a plurality of trainable encoder weights. Examples of this encoder were shown in FIGS. 5 and 6. In some embodiments, the encoder module is configured to transform input information symbols of a 16-Quadrature Amplitude Modulation (16-QAM) alphabet into two-dimensional symbols for transmission through the communications channel. Other modulation orders or modulation schemes may be employed, in other embodiments.

In some embodiments, the encoder module implements an artificial neural network, and the plurality of trainable encoder weights comprise trainable ANN weights. The encoder module may be implemented in a radio transmitter, e.g., using analog and/or digital processing circuitry to implement the encoder, in which case it may be regarded as an encoder circuit. Such an encoder circuit may comprise, for example one or more processors and associated memory, with the memory storing program code for execution by the processor(s) and the program code being configured to cause the processor(s) to carry out the encoding functionality described above.

In addition to the decoder apparatus and the encoder module, the communication system described immediately above may further comprise an optimization module configured to receive a plurality of the input information signals and corresponding ones of the output information symbols and to adapt the trainable encoder weights and trainable QNN weights for input to the encoder circuit and QNN, respectively, based on the plurality of the input information signals and the corresponding ones of the output information symbols. The optimization module, which completes a loop between the output from the QNN and the weights applied to the encoder and the QNN, is configured to jointly optimize the encoder weights and the QNN weights using a categorical cross-entropy loss function. This optimization is performed during a training phase, which may be performed off-line, e.g., using a simulated radio channel, or “on-line,” over a real-world channel. Such training may be performed intermittently, in some embodiments or instances, so that the system may adapt to a changing environment and radio channel.

The optimization module 550 discussed in detail above is one example of such an optimization module. This and other embodiments of the optimization module may be implemented using classical processing circuitry, e.g., one or more processors and associated memory storing program code for execution by the processor(s), or using one or more quantum-processing units (QPUs), or some combination of both. The optimization module implements part of a training loop, which iteratively performs a series of optimization steps to search for improved trainable parameters in the neural networks. The optimization functionality can be implemented as an arbitrary optimizer, such as the Adam optimizer. But, this classical method can be replaced by, for example, quantum annealing optimization, when such functionality performs well enough. More generally, the optimization module is a computing engine, using hardware, software, or quantum processing resources, or combinations thereof to produce optimal parameters for the NNs.

FIG. 7 illustrates an example method for quantum decoding, according to various embodiments of the techniques described above. As shown at block 730, the method comprises receiving an output from a communications channel that comprises a radio channel. The method further comprises decoding the output into output information symbols, in a quantum circuit comprising a QNN with a plurality of trainable QNN weights, as shown at block 740.

As in the various examples described above, the QNN comprises at least a first embedding layer, configured to receive the output from the communications channel and to encode the output into first qubits, and a first transforming layer, configured to transform the qubits using a plurality of quantum gates, wherein the first embedding layer implements weighted rotation angle embedding of the output from the communications channel using at least a first trainable weight.

The quantum gates of the first transforming layer may likewise incorporate at least a second trainable weight. In some embodiments, the plurality of quantum gates of the first transforming layer includes one or more rotation gates for each of a plurality of qubits, each of one or more of the rotation gates having trainable rotation parameters, and further includes one or more CNOT gates arranged to entangle the qubits.

In some embodiments or instances of the method shown in FIG. 7, the method further comprises, in an encoder separated from the decoder apparatus by the communications channel, transforming input information symbols into a two-dimensional signal space for transmission through the communications channel, using a plurality of trainable encoder weights. This is shown at block 720. In some of these embodiments, this transforming comprises transforming input information symbols of a 16-Quadrature Amplitude Modulation (16-QAM) alphabet into two-dimensional symbols for transmission through the communications channel. This transforming may use an artificial neural network, where the plurality of trainable encoder weights comprise trainable ANN weights.

In some further embodiments or instances of the illustrated method, the method further comprises, in an optimization module, receiving a plurality of the input information signals and corresponding ones of the output information symbols and adapting the trainable encoder weights and trainable QNN weights for input to the encoder circuit and QNN, respectively, based on the plurality of the input information signals and the corresponding ones of the output information symbols. This is shown at block 710. This adapting may comprise jointly optimizing the encoder weights and the QNN weights using a categorical cross-entropy loss function.

Advantages of various embodiments of these apparatuses, systems, and methods include that, by using QNNs instead of classical ANNs, the decoders described herein can leverage the representation capacity of quantum circuits to solve complex nonlinear scenarios in classical communication. Further, by using QNNs instead of classical ANNs, the size of the neural network in the decoder can leverage compact quantum circuit representations and nice scaling properties, with problem size of higher order QAM.

With the proposed data encoding schemes and re-uploading methods, a more compact and faster QNN can be created. The QNN solution can leverage early, noisy, Quantum Processing Units (QPUs).

Integration to classical system is described, with end-to-end training loop for encoder-decoder optimization. Inference can easily leverage QPU acceleration once a trained system is used with QNN-based decoder.

### ABBREVIATIONS

QML Quantum Machine Learning
QNN Quantum Neural Network
ANN Artificial Neural Network
NN Neural Network
QAM Quadrature Amplitude Modulation
AE Autoencoder
QAE Quantum Autoencoder
SNR Signal-to-Noise Ratio
SER Symbol Error Rate
QPU Quantum Processing Unit
AWGN Additive white Gaussian Noise

1-16. (canceled)

17. A decoder apparatus comprising:
a quantum circuit configured to receive an output from a communications channel that comprises a radio channel, and to decode the output into output information symbols, the quantum circuit comprising a quantum neural network (QNN) with a plurality of trainable QNN weights,
wherein the QNN comprises at least a first embedding layer, configured to receive the output from the communications channel and to encode the output into first qubits, and a first transforming layer, configured to transform the qubits using a plurality of quantum gates, wherein the first embedding layer implements weighted rotation angle embedding of the output from the communications channel using at least a first trainable weight.

18. The decoder apparatus of claim 17, wherein the plurality of quantum gates of the first transforming layer incorporate at least a second trainable weight.

19. The decoder apparatus of claim 18, wherein the plurality of quantum gates of the first transforming layer (includes one or more rotation gates for each of a plurality of qubits, each of one or more of the rotation gates having trainable rotation parameters, and further includes one or more CNOT gates arranged to entangle the qubits.

20. A communication system comprising the decoder apparatus of claim 17, the communication system further comprising an encoder module configured to transform input information symbols into a two-dimensional signal space for transmission through the communications channel, using a plurality of trainable encoder weights.

21. The communication system of claim 20, wherein the encoder module is configured to transform input information symbols of a 16-Quadrature Amplitude Modulation (16-QAM) alphabet into two-dimensional symbols for transmission through the communications channel.

22. The communication system of claim 20, wherein the encoder module implements an artificial neural network and wherein the plurality of trainable encoder weights comprise trainable ANN weights.

23. The communication system of claim 19, further comprising an optimization module configured to receive a plurality of the input information signals and corresponding ones of the output information symbols and to adapt the trainable encoder weights and trainable QNN weights for input to the encoder circuit and QNN, respectively, based on the plurality of the input information signals and the corresponding ones of the output information symbols.

24. The communication system of claim 23, wherein the optimization module is configured to jointly optimize the encoder weights and the QNN weights using a categorical cross-entropy loss function.

25. A method for quantum decoding, the method comprising:
receiving an output from a communications channel that comprises a radio channel; and
decoding the output into output information symbols, in a quantum circuit comprising a quantum neural network (QNN) with a plurality of trainable QNN weights;
wherein the QNN comprises at least a first embedding layer, configured to receive the output from the communications channel and to encode the output into first qubits, and a first transforming layer, configured to transform the qubits using a plurality of quantum gates, wherein the first embedding layer implements weighted rotation angle embedding of the output from the communications channel using at least a first trainable weight.

26. The method of claim 25, wherein the plurality of quantum gates of the first transforming layer incorporate at least a second trainable weight.

27. The method of claim 26, wherein the plurality of quantum gates of the first transforming layer includes one or more rotation gates for each of a plurality of qubits, each of one or more of the rotation gates having trainable rotation parameters, and further includes one or more CNOT gates arranged to entangle the qubits.

28. The method of claim 25, further comprising, in an encoder separated from the decoder apparatus by the communications channel, transforming input information symbols into a two-dimensional signal space for transmission through the communications channel, using a plurality of trainable encoder weights.

29. The method of claim 28, wherein said transforming comprises transforming input information symbols of a 16-Quadrature Amplitude Modulation (16-QAM) alphabet into two-dimensional symbols for transmission through the communications channel.

30. The method of claim 28, wherein said transforming uses an artificial neural network and wherein the plurality of trainable encoder weights comprise trainable ANN weights.

31. The method of claim 27, further comprising, in an optimization module, receiving a plurality of the input information signals and corresponding ones of the output information symbols and adapting the trainable encoder weights and trainable QNN weights for input to the encoder circuit and QNN, respectively, based on the plurality of the input information signals and the corresponding ones of the output information symbols.

32. The method of claim 31, wherein said adapting comprises jointly optimizing the encoder weights and the QNN weights using a categorical cross-entropy loss function.
